(19) United States
(12) Patent Application Publication
(10) Pub. No.: US 2005/0166521 A1
(43) Pub. Date: Aug. 4, 2005

(54) Lattice tower disguised as a monopole

(76) Inventor: Meir Silber, Budapest (HU)

Correspondence Address: FITCH, EVEN, TABIN & FLANNERY, P. O. BOX 65973, WASHINGTON, DC, 20035, US

(21) Appl. No.: 10/509,254

(22) PCT Filed: Apr. 3, 2003
(86) PCT No.: PCT/HU03/00026

(30) Foreign Application Priority Data
Apr. 3, 2002 (HU) P0201136

(51) Int. Cl. E04B 1/18

(52) U.S. Cl. 52/633; 52/651.01

(57) ABSTRACT

A solution for a tower (10) that may be substantially tall, characterized by the appearance of a monopole, the capacity to support large objects and consequently sustain great lateral loads generated by wind or earthquake, the facility to conceal vertical access ladder and all other installations, such as antenna feeder cables, and the availability at an acceptable cost level.

The heart of the invention is the basic concept of separation between the structurally functioning elements, which are kept concealed, and a non-structural shell (12) which provides the tower (10) the shape of a monopole.

The tower (10) comprises, therefore, a tall metal lattice structure (14) having a central vertical axis (1) and certain apparatus for its anchoring to a foundation, concealed within a shell (12) concentric with said central vertical axis (1) and further characterized, at any given level, by a closed cross-section which is either circular or equi-sided polygonal, said shell (12) being internally secured to and supported by said lattice metal structure (14) in an appropriate density throughout its area, so as to maintain its shape when subjected to wind loads or any other likely loads.

### FIELD OF THE INVENTION

The present invention relates generally to tall tower structures and, in particular, to towers supporting telecommunication antennae, wind-turbines, large signage or the like.

### BACKGROUND OF THE INVENTION

The numbers of tall tower structures required globally are consistently increasing in recent years. The major industry sector leading said growth is undoubtedly the telecom sector, but there are several non-telecom applications as well, that require tall towers of possible similar visual and structural properties, such as wind-turbines generating electrical power, large commercial signage of any type or the like.

The vast majority of said towers are made of steel, though other materials, such as concrete or wood, are also used for making towers, yet in much smaller proportions.

A tower made of steel may be constructed as one of two main structural types: as a Lattice Tower, constructed of a plurality of beams and struts, structurally acting altogether as a space frame, or as a Monopole, consisting a single solid vertical body, structurally acting as a vertical beam.

Most lattice towers are tapered structures, having three or four continuous leg members, between which a large number of lattice members, horizontals and diagonals, interconnect in various elevation increments.

Most monopoles are made of a closed hollow cross-section, which may be round or an equi-sided polygon, and are also tapered along their vertical axis, either continuously or in individual incremental steps.

A lattice tower would normally present a more economical solution for a given loading and height requirement, especially when the elastic angular deflection of the top of the tower must be limited, as the case is in most telecom applications (particularly where micro-wave transmission antennae are used, as the tolerable angular deviation of such antennae, due to wind actions on the entire tower, relative to an originally aligned state, are very limited).

Furthermore, the higher the required tower is, and the larger the required load capacity goes, the larger the cost difference tends to be (percentage wise) between a lattice tower solution and a monopole solution (for the same height and load requirement).

On the other hand, monopoles present normally a much more aesthetical solution, compared to a lattice tower, as they employ normally a much slimmer construction than lattice towers, which is also characterized by a neater appearance. Even when the monopole is not slimmer than a lattice tower would be, it would normally be considered more aesthetical, as in most such cases a great part of the installations, which are all exposed to sight in the case of a lattice tower, may be concealed in the case of a monopole (for example: antenna feeder cables, or even the vertical access ladder in some cases).

Hence there is a felt tendency of building permitting authorities, especially in countries where environmental considerations play a significant role, to encourage applicants, especially telecom network operators, to adopt an increasing proportion of monopole solutions for their required tower needs, despite the higher cost implications.

Narrowing the observation now to the telecom industry, particularly the cellular networking sector, there is also a felt tendency of building permitting authorities to encourage telecom operators to build shared sites with other operators, rather than building a plurality of neighboring individually utilized sites. At the same time, with the rapid evolution of cellular telecommunication technologies, many telecom operator are bound to deploy a plurality of network infrastructures, conforming with a plurality of technology generations, which means a further increase in antenna and feeder cable loadings on the average tower.

However, it will be appreciated by persons skilled in the art that, while the industry developed numerous effective and reasonably aesthetical monopole solutions supporting very few networks (normally a single network, and very seldom more than three networks, belonging to same operator or different operators), there are very few solutions of acceptable cost levels (if any) for monopoles that can support a large number of networks (belonging to several operators), and consequently a large number of antennas and feeder cables. Furthermore, the capacity of most known in the art monopole solutions to conceal feeder cables within their cross-section is still rather limited, for a variety of reasons related to installation practices.

Accordingly, there is a felt need for, and an expected welcoming acceptance of, a solution for a tower that would be characterized by the appearance of a monopole, the capacity to support a large number of networks, in terms of wind-load resistance as well as in terms of the capacity to conceal feeder cable routs and preferably the vertical access ladder as well, yet most importantly—be available at an acceptable cost level.

### PRIOR ART PUBLICATIONS

A large number of patents, patent applications and other prior art publications relate to antenna towers or the like, including monopole type towers.

The following publications are believed to be the most relevant for reference as prior art herein:

Disclosed in U.S. Pat. No. 6,286,266 to POPOWYCH et al. is a tree styled monopole tower.

Disclosed in International Patent Application No. PCT/SE94/01194 to DAVIDSSON et al. is a (monopole) tower serving as an antenna carrier, and having a space for electronic equipment, such as radio equipment, provided in connection therewith.

Disclosed in U.S. Pat. No. 5,969,693 to LEGG is an enclosed multi-user telecommunications tower covering multiple antennas at various heights.

Disclosed in Japan Patent Application No. 11094318 to TAKADA HIROO KANEMOTO KIYOOMI is a communication tower which is not easily damaged by its meteorological situation or peripheral environment and can particularly improve the durability of a transmitting/receiving device.

Disclosed in U.S. Pat. No. 5,375,353 to HULSE is an illuminated sign assembly for use on a communications antenna tower.

The tree styled monopole tower to POPOWYCH et al. is in fact, by its structural properties, a conventional structural shell hollow monopole (made of steel normally), and the novelty therein relates merely to the means used to make said structurally conventional monopole appear visually as a tree.

The (monopole) tower serving as an antenna carrier to DAVIDSSON et al. is also, by its structural properties, a conventional structural shell hollow monopole (made of steel normally), and the novelty therein relates merely to the facility to house electronic equipment within the bottom portion of the hollow (structural) section of the monopole.

In the multi-user telecommunications tower to LEGG, the tower is indeed large enough, by its cross-section, to house the vertical means of access as well as all the installations, however this is also a structural shell construction, without an internal structure, and said structural shell is envisioned therein to be made either of reinforced concrete or of structural steel.

In the communication tower to TAKADA HIROO KANEMOTO KIYOOMI, there is indeed provided a non-structural shell, but there the shell is provided primarily in order conceal transmit/receive antennae, it must therefore be made of a magnetically permeable material, which may or may not have also a structural role. Nevertheless, as opposed to the present invention, the presence of antennas concealed by said shell is of the essence of that invention, and there is no evidenced need for an internal supporting lattice structure.

The illuminated sign assembly for use on a communications antenna tower to HULSE is indeed the publication which is at shortest distance to the present invention, as there is also an internal supporting lattice structure encircled by a non-structural concealing cover. Nevertheless, the purpose for which the lattice structure in the present invention is encircled in a non-structural shell is completely different than the purpose of doing the same in the assembly to HULSE, and resultantly, the shape of the shell, the materials used and the details of its construction are totally different:

The assembly to HULSE is aimed to include as large as possible planar envelope surfaces, with relatively large clearance from the supporting lattice structure (for illumination purposes) all made for the purpose of posting illuminated signage thereon, while in the present invention the aim is to minimize notability and especially wind-drag loads, and therefore the non-structural shell fits as tightly as possible the supporting lattice structure, and has a cross-sectional shape which is as close as possible to a circle.

Furthermore, in the assembly to HULSE, the material used to form the envelope, at least at the illuminated planar parts, is a fabric which allows the effect of interior lighting to be utilized. In the present invention, on the other hand, there is no meaning to using a light permeable material, and the direction is rather to use shell materials that have a minimal extent of flexural rigidity, in order to durably maintain the shape of the shell within the spans between the securing supports to the internal lattice structure.

### SUMMARY OF THE INVENTION

It is the aim of the present invention is to provide an efficient solution for a tower that would combine the load bearing capacity and cost effectiveness of a metal lattice tower with the aesthetic advantages generally attributed to monopoles. The heart of the invention is the basic concept of separation between the structurally functioning elements, which are kept concealed, and a non-structural shell which provides the tower the shape of a monopole.

There is provided, therefore, a tower, comprising a tall metal lattice structure having a central vertical axis and certain apparatus for its anchoring to a foundation, concealed within a shell concentric with said central vertical axis and further characterized, at any given level, by a closed cross-section which is either circular or equi-sided polygonal, said shell being internally secured to and supported by said lattice metal structure in an appropriate density throughout its area, so as to maintain its shape when subjected to wind loads or any other likely loads.

According to one embodiment of the present invention, said lattice structure includes at least three continuous leg members, each having either uniform or varying cross-section along its height, the axis of each leg being defined by either a straight or a broken line, contained within a vertical radial plane that is defined by and contains also said central vertical axis, said shell has the shape of either a cylinder or a truncated cone with a circular cross-section, or a prism or a truncated pyramid with an equi-sided polygonal cross-section, and means for securing said shell to said lattice structure comprises an array of sufficiently stiff horizontal metal rings, having a respective circular or equi-sided polygonal shape, encircling and well fastened to said lattice structure, each in its designated level, the axes of all said rings being collinear with said central vertical axis and their exterior surfaces matching the internal surface of said shell in said designated levels respectively, said shell being mounted onto said array of rings and fastened thereto.

According to another embodiment of the present invention, the entire height of said shell is divided, for fabrication and assembly purposes, into a plurality of separable shell sections respectively, each having transportable dimensions, such that each shell section is directly fastened to at least one of said metal rings, and the joint between every two adjacent said shell sections, once finally assembled, is made such that the bottom end of the upper of said sections is extending over the top end of the lower of said sections, so that a relatively small overlap exists there between, allowing vertical slip of the interior surface of the upper section relative to the exterior surface of the lower section.

According to yet another embodiment of the present invention, said joint is made such that a small gap exists between the exterior of the top end portion of the lower of said every two adjacent shell sections and the interior of the bottom portion of the upper of said two sections, and said gap is filled with a band of an elastic material, such as rubber, said band fulfilling a primary role of transmitting lateral forces between the bottom end of said upper section and the top end of said lower section while minimizing the transmission of vertical forces there between, and a secondary role of sealing the joint against wind-air or rain-water penetration; the top portion of the lower of said every two adjacent shell sections, where said joint is located, is dropped inwards all around, so as to make room for said overlap and said gap, while keeping a substantially smooth and continuous exterior face of said shell sections on both sides of said joint, and each of said shell sections being fastened to only one of said metal rings, located behind the top end portion of the respective shell section.

According to yet another embodiment of the present invention, each, or any desired part of, said shell sections is further divided, for fabrication and assembly purposes, into a plurality of horizontally spaced apart segments, such that every two adjacent segments are coupled along a substantially vertical seam there between, said seam being made by two internally bent and vertically abutting lips, each forming an integral part of a respective one of said two adjacent segments, such that a substantially vertical radial plane of contact exists there between, which is defined by and contains also said central vertical axis, said two abutting lips being mechanically coupled by means of conventional bolting, riveting, gluing or the like.

According to a much different embodiment of the present invention, said means for securing said shell to said lattice structure forms a part of the structure of said shell, and comprises an array of sufficiently stiff, horizontally spaced apart metal profiles, well fastened to said lattice structure, the axis of each of said metal profiles being contained within a vertical radial plane that is defined by and contains also said central vertical axis; Said shell being divided by said array of metal profiles into an array of separable longitudinal shell segments, each of said longitudinal segments being fastened, along both its longitudinal, substantially vertical edges, to two of said metal profiles, adjacently located.

According to another embodiment of the present invention, each of the separable longitudinal shell segments described above is substantially planar, consequently the entire said shell has a shape of a prism or a truncated pyramid, with an equi-sided polygonal cross-section, and the entire shell is divided along its entire height into a plurality of separable shell sections, such that in every joint between every two adjacent shell sections:
said metal profiles are set apart into separate co-axial profile section, with a relatively small gap there between, and
said longitudinal shell segments are set apart into separable segment sections as well, but such that the upper segment section is extended, at its bottom, so as to overlap a relatively small portion at the top of the lower segment section in the joint.

The invention details several embodiments of the possible arrangements at a corner line of the shell, between one of the metal profiles described above and two longitudinal edges of said longitudinal shell segments, abutting said metal profile at both its sides, including the specific means of connection there between.

The invention further envisions the use of either fiberglass material or any other composite material, or a polymeric material sheeting, or a relatively thin metal sheeting, for the purpose of making the entire shell, or its longitudinal segments fitting in between the metal profiles, as applicable.

### BRIEF DESCRIPTION OF THE DRAWINGS

The present invention, as well as some preferred embodiments thereof, may be best understood and appreciated from the following detailed description made in conjunction with the drawings in which:

FIG. 1 is a schematic isometric view of a tower constructed in accordance with a general embodiment of the present invention;

FIG. 2 is a series of schematic isometric views illustrating several common applications, in which a tower constructed in accordance with the present invention may be used;

FIG. 3 is a schematic vertical cross-sectional view of a tower constructed in accordance with one specific embodiment of the present invention;

FIG. 4 is a schematic horizontal cross-sectional view of the tower illustrated in FIG. 3, taken at the 4-4 section-mark plane thereon;

FIG. 5 is a schematic vertical cross-sectional view of a tower constructed in accordance with another specific embodiment of the present invention;

FIG. 6 is an enlargement of the joint detail between two adjacent shell sections forming part of the tower illustrated in FIG. 5;

FIG. 7 illustrates two alternative embodiments for the construction of every single shell section of a plurality of horizontally spaced apart segments;

FIG. 8 is a schematic isometric view of a tower constructed in accordance with yet another embodiment of the present invention;

FIG. 9 is a schematic horizontal cross-sectional view of the tower illustrated in FIG. 8;

FIG. 10 illustrates four alternative embodiments for the construction of every corner line of the shell of the tower illustrated in FIG. 8, shown as possible alternative enlargements of the encircled corner detail in FIG. 9.

### DETAILED DESCRIPTION OF THE INVENTION

The objective of the present invention is to provide a solution for a tower that may be substantially tall, would be characterized by the appearance of a monopole, the capacity to support great lateral loads effected upon the objects supported by it by natural forces, such as wind or earthquake, the facility to conceal vertical access ladder and all other installations, such as antenna feeder cables, yet most importantly—be available at an acceptable cost level.

The heart of the present invention is the basic concept of separation between the structurally functioning elements, which are kept concealed, and a shell which provides the tower its shape, resultantly also governing the lateral wind-drag loads to which the tower will be subjected, yet otherwise said shell has no structural role. The various alternatives for constructing said shell, and the details used therefore, are also important elements of the invention.

Thus, the present invention facilitates the utilization of a tall lattice structure, of any desired type, considering almost exclusively one target-function only: the cost-effectiveness of the structure. Said cost-effectiveness consideration gets much simplified by itself, as parameters such as the aero-dynamic properties of the structural members, which have significance in a normal, exposed to the wind, lattice tower case, can be totally ignored in this case.

Another advantage of the present invention, compared to conventional monopoles this time, is the much higher dimensional freedom: in a conventional hollow steel monopole, the structural action is that of a thin shell (not to be confused with the non-structural shell in the present invention). Being subjected to substantial magnitude moments, particularly at its bottom part, one half of said monopole's cross-section experiences significant resulting compressive stresses. In order to sustain said compressive stresses, and be immune to the risk of local shell buckling, the various standards prescribe relevant allowable ratios between the diameter of such a structural shell's cross-section and its wall thickness. In other words, regardless of the specific standard being followed and the exact cross-sectional shape being used (circular or polygonal), the general rule in the design of conventional monopoles, utilizing a structural shell, is that the larger the cross-sectional diameter is (a desirable increase for the purpose of limiting deflections)—the thicker the shell's wall must be, consequently the much heavier the respective monopole section becomes.

In the present invention, however, the structural shell function is absent, as the shell in this case is a non-structural facade only. Instead, the structural function is identical to that of any lattice tower, wherein a “tradeoff” relation generally exists between the width of the structure (resultantly the cross-sectional diameter of the covering shell, in our case) and the required legs' cross-sectional area, which to a great extent governs the weight of the metal structure. In other words: the wider the structure is allowed to be (within reasonable limits) the lighter it would become. The non-structural shell is kept substantially free of compressive stresses and therefore, with the provision of securing to the concealed lattice structure in a sufficient density, it may be kept as thin as practically manageable.

As a general conclusion it may be summarized, that the larger the cross-sectional diameter of the monopole needs, or is allowed, to be—the greater the advantages and benefits of utilizing the present invention become, compared to a conventional hollow steel monopole.

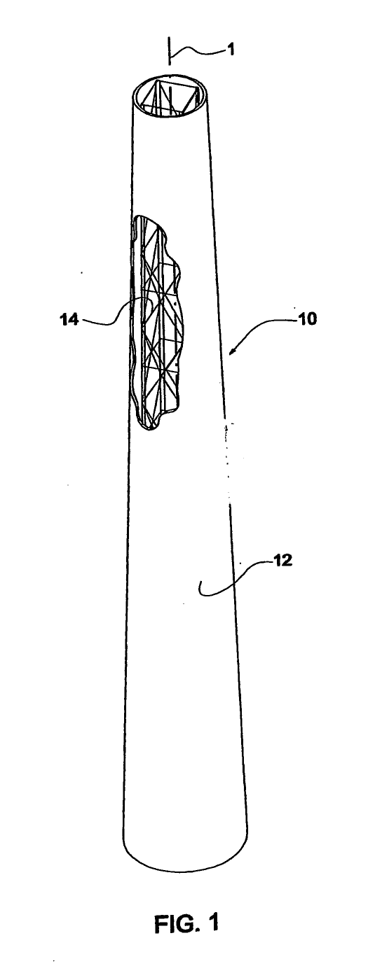

Referring now to FIG. 1, there can be seen a tower 10 constructed according to a basic embodiment of the present invention. Tower 10 comprises a tall metal lattice structure 14 having, in the illustrated embodiment, a square cross-section (and consequently four legs), which is encircled totally by a thin shell 12. The tall structure 14 and the shell 12 have a common central vertical axis 1. It will be appreciated that shell 12, having in the illustrated embodiment a circular cross-section, could just as well be characterized by an equi-sided polygonal cross-section.

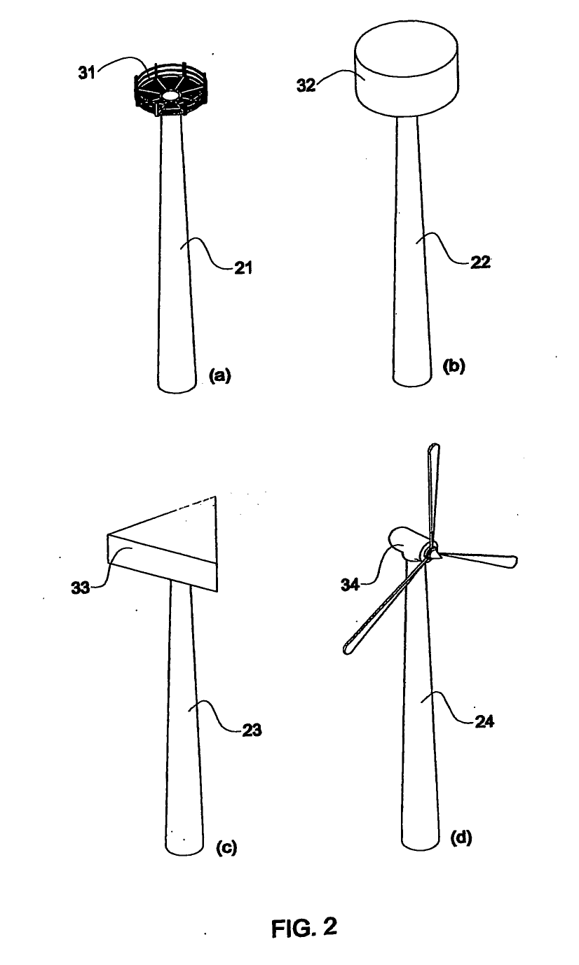

FIG. 2 illustrates four different sample applications in which a tower utilizing the present invention may be used:

FIG. 2(a) illustrates a telecommunication application, wherein tower 21 supports an open antenna mounting platform 31;

FIG. 2(b) illustrates a telecommunication application as well, but in this case tower 22 supports a special enclosure 32 for the antennae;

FIG. 2(c) illustrates a commercial application, wherein tower 23 supports a large triangular signage 33, of the type commonly used for brand-signing in shopping-parks;

FIG. 2(d) illustrates an industrial application, wherein tower 24 supports a wind turbine 34 generating environmentally clean electrical power.

The vast majority of metal lattice tower structures include three or four continuous leg members, among which a plurality of lattice members (diagonals and horizontals) interconnect. The same vast majority of said structures are characterized by a polar symmetry around a central vertical axis. Owing to said symmetry, and as will be appreciated by persons skilled in the art, it would be a rather straightforward exercise to design, fabricate and install on such a tower an array of vertically spaced apart horizontal metal rings, their centers lying on said central vertical axis.

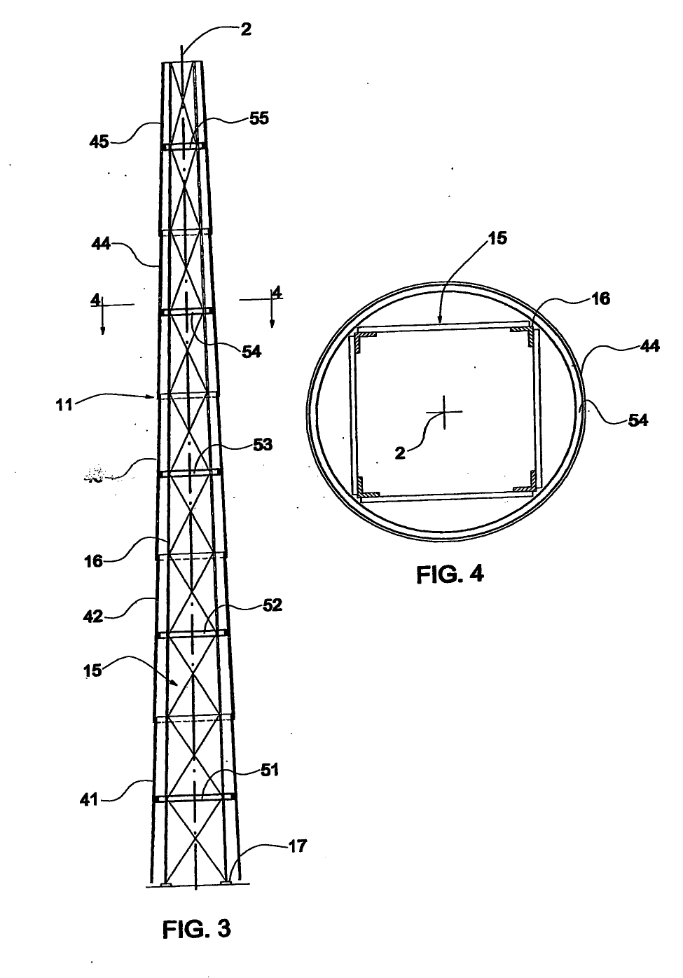

Referring now to FIG. 3, there is an illustration of a tower 1, constructed according to another embodiment of the present invention. Here again, the interior of the tower is a tapered lattice structure 15 of a square cross-section, having four legs 16. Said tapered lattice structure has a clearly definable central vertical axis 2, as well as apparatus 17 for anchoring the tower base to a foundation.

Along the height of the tower illustrated in FIG. 3 there are shown five horizontal metal rings 51, 52, 53, 54 and 55, each having a diameter large enough to encircle the lattice structure at its installation height.

FIG. 4, which is a horizontal cross-section of the tower illustrated in FIG. 3, taken at the plane marked by section-mark 4-4 therein, shows that the shape of ring 54, as well as all the other rings in this embodiment, is circular. It will be again appreciated that the shape of all similar rings, in a not much different embodiment, could be an equi-sided polygon.

The most effective structural connection between said rings and said lattice structure can be achieved, as will be appreciated by persons skilled in the art, if said connection is made directly between each of said rings and the legs of the lattice structure. This type of connection, by itself, would be most effective if the ring is sized such that the clearance between its internal side and each of the tower legs is kept minimal. This desirable relation between ring 54 and tower legs 16 of tower 11 (made in this embodiment of “L” shape metal members) is illustrated in FIG. 4, however the exact connection there between is not shown, as it may be any desired type out of numerous connection and fastening means known in the art, which may be applicable to this case.

Once the tower is equipped with an array of metal rings, as described above, and said rings are designed such that their exterior surfaces match the interior surface of the non-structural shell, the mounting of said shell onto said metal rings and the provision of appropriate fastening there between is a rather straightforward exercise.

In order to keep the non-structural shell, constructed in accordance with the present invention, as thin and low-cost as possible, it is important to ensure that said shell would be subjected to smallest possible loads and resultant stresses. It is therefore vital to construct the shell such that, when the tower experiences lateral loads (due to wind or earthquake, for example) these loads be handled solely by the interior lattice structure, and not develop any substantial compressive or tensile stresses in the shell itself.

In the present invention, the primary measure by which the above mentioned non-structural function of the shell is ensured is the division of the entire height of the shell into a plurality of short enough shell sections, such that vertical compressive or tensile stresses may not be transferred through the joints there between.

FIG. 3 illustrates a simple embodiment of a shell, constructed in accordance with the above mentioned principles of dividing the entire shell's height into individual shell sections: the entire shell of FIG. 3 is divided into five individual conical sections 41, 42, 43, 44 and 45. Each of said sections (except the bottom one) overlaps the section below it over a relatively small portion, such that in said portion the interior surface of the upper section of the two substantially abuts the exterior surface of the lower section of the two.

Hence, in the construction illustrated in FIG. 3, when the entire tower experiences lateral loads and resultantly bends accordingly, the abutting portions of the shell sections may slip one relative to the other, a slipping that prevents the transfer, and therefore also the build-up, of resultant vertical compressive or tensile stresses. The same construction also prevents the build-up of similar stresses resulting from temperature gradients, which may naturally develop due to un-symmetrical exposure to sun during daytime, for example.

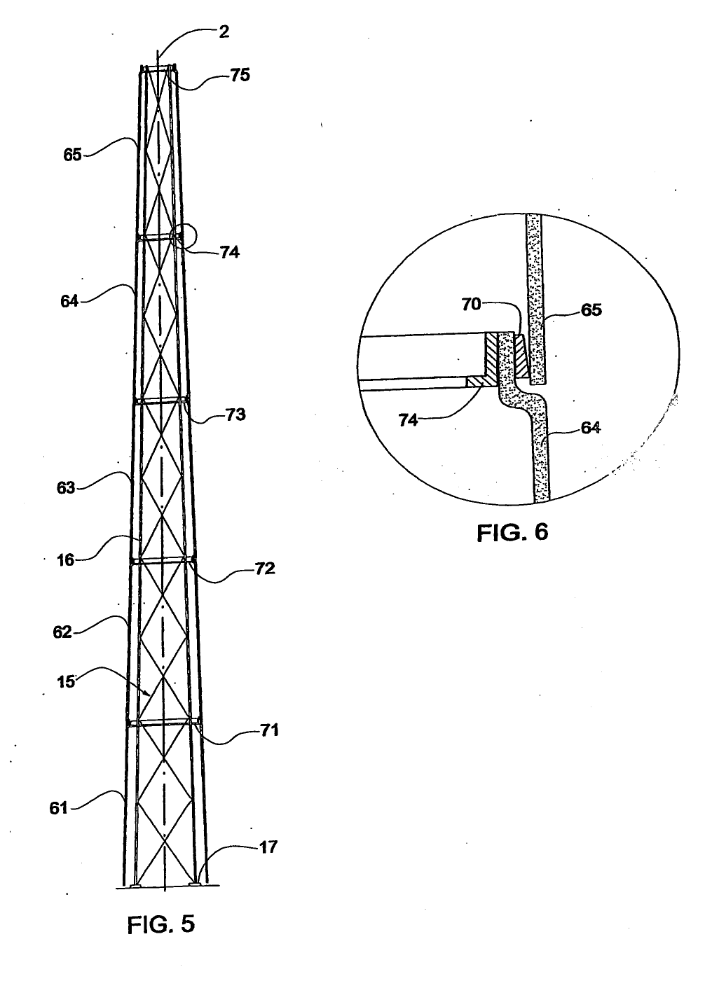

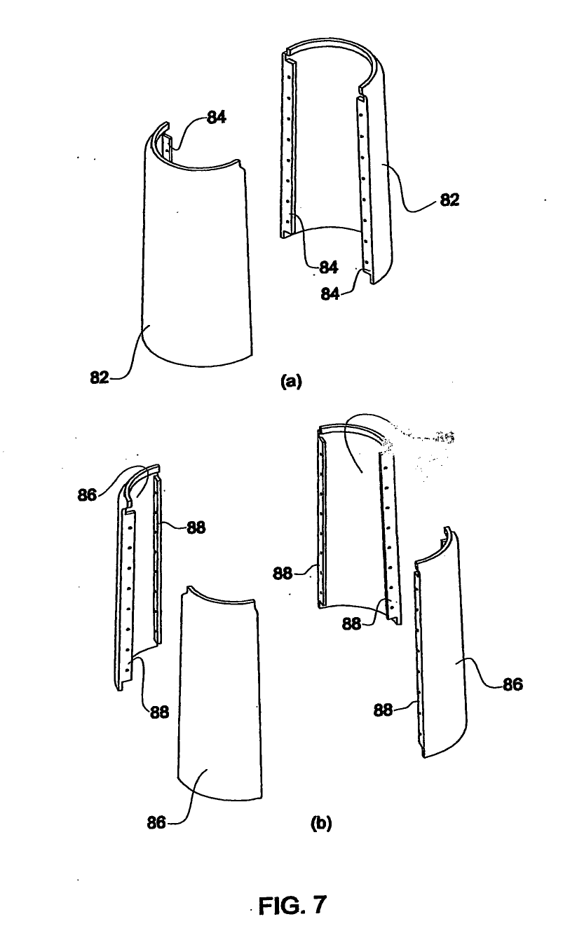

FIGS. 5 and 6 illustrate an improved practical solution incorporating basically the same principles as described above and illustrated in FIGS. 3 and 4. The said improvement, which are described below in detail, may be either incorporated fully altogether, or only partly incorporated.

There is no difference whatsoever between the internal metal structures 15 illustrated in both FIG. 3 and FIG. 5. Furthermore, shell sections 61 through 65 of FIG. 5 have the same basic role as shell sections 41 through 45 of FIG. 3, and supporting metal rings 71 through 75 of FIG. 5 have the same basic function as supporting metal rings 51 through 55 of FIG. 3.

The first step improvement involves two measures: (a) The provision of a relatively small gap in said overlapping portion between every two adjacent shell sections, between the interior surface of the upper section and the exterior surface of the lower, and: (b) The provision of a band made of an elastic material, such as rubber, fitted in its cross-sectional dimensions to fulfill its purpose, as described below. One embodiment of said band's cross-section 70 is illustrated in FIG. 6.

The advantages achieved by said first step improvement are as follows: First—the dimensional accuracy requirement in the fabrication of the shell sections is substantially alleviated, compared to the case where two adjacent section surfaces must abut each other directly; Second—transferability of vertical forces in between every two joining shell sections may be minimized, while efficient transferability of lateral forces there between is ensured (for this purpose, the band material and cross-section must be appropriately selected, so as to minimize vertical friction while providing reasonably high lateral modulus of elasticity of the band); And third—the joint is efficiently sealed against penetration through the shell of either wind-air or rain-water.

The second step of said improvement involves designing said shell sections such that the top end portion of each is dropped inwards, forming a “shoulder and neck” shape, to a dimensional extent that allows the provision of said overlap and said gap between the overlapping portions simultaneously with maintaining a smooth appearance of the entire shell, i.e. that the exterior faces of all the shell sections define a single conical (or cylindrical) surface. The cross-sectional detail in FIG. 6 illustrates said “shoulder and neck” shaped arrangement in the joint between shell sections 64 and 65. Apart from the obvious aesthetical value of this second step improvement, it also contemplates a certain aero-dynamical advantage reducing wind drag forces, but in rather minimal extent and importance.

It will be appreciated by any person skilled in the art, that each individual shell section may be secured to the lattice structure by either a single said metal ring or by a plurality of such vertically spaced apart rings. Nevertheless, when a plurality of said rings is used to secure each shell section, the risk of undesirable transferability of stresses between the internal lattice structure and the shell increases. Therefore, in the preferable embodiments, each shell section is supported by only a single said metal ring.

It will be further appreciated that each of said supporting metal rings may be located in various possible levels relative to the respective supported shell section. Hence, in FIG. 3 it can be seen that each of the metal rings 51 through 55 is located substantially at mid-height of each of respective shell sections 41 through 45, while in FIG. 5 each of the metal rings 71 through 75 is located at the top of each of respective shell sections 61 through 65, right behind the narrowed portion.

Indeed, the various ring locations are all feasible, however the location of each ring at the top of the respective supported shell section, as illustrated in FIG. 5, contemplates certain advantages, as every intermediate shell section is supported, against lateral loads, at both its top and its bottom, and furthermore since the self weight of the shell section causes only vertical tensile stresses which are, in the case of thin shells, more favorable than compressive stresses.

Depending on fabrication considerations and limitations, the materials used as well as some other relevant considerations, each shell section may be fabricated as a single monolithic unit, or alternatively further broken down into a plurality of horizontally detachable segments.

Quite obviously, each shell section may be built of any desired number of detachable segments.

In case the shell sections are indeed broken down to detachable segments, the most reasonable arrangement would be that which maintains highest degree of simplicity, polar symmetry and component uniformity. A general arrangement which fulfills the aforesaid is such where the seams between every two adjacent segments lie on vertical radial planes, passing through the tower's central vertical axis.

Numerous details may be incorporated to make said seams between every two adjacent segments. Nevertheless, there are clear advantages to a seam detail which keeps the entire fastening means concealed, and involves no protrusions whatsoever from the shell's outer surface.

FIG. 7 illustrates two embodiments of the preferred solution for the braking down a shell section into a plurality of detachable segments, and making the seam there between: In FIG. 7(a) there can be seen a conical shell section built up from two identical shell segments 82. The means for seaming between said two segments comprises internally bent, substantially vertical planar lips 84, containing holes for fasteners. When the segments are coupled, every two respective lips 84 abut each other such that their plane of contact is substantially a vertical radial plane, passing through the tower's central vertical axis. The means for fastening every said two abutting lips 84 may be any practical fastening means known in the art, such as bolting, riveting, gluing or the like.

FIG. 7(b) is different from FIG. 7(a) only in terms of the number of segments comprising a single shell section, which is four identical shell segments 86 in this case. Otherwise, seam lips 88 have exactly the same role, and may have exactly the same shape, as seam lips 84.

The non-structural shell of the tower may be made of a variety of possible materials. One family of such materials is the composite materials, of which the fiberglass material is the lowest cost and most commonly available material. The advantage of the composite materials is the relative ease in which these materials may be shaped using relatively low cost molds. Certain precautions should be exercised, however, when utilizing composite materials, especially to the long-term durability and resistance to likely environmental effects, such as the sun's ultra-violet radiation.

Of course, the thin non-structural shell may also be constructed of any desirable metal sheeting, in a process involving cutting, bending and possibly also welding.

The detailed description has related, up to this point, to a series of embodiments wherein the shell sections are either monolithic in their fabrication or, if made up of several segments, they may be assembled into complete shell sections independently from the internal support elements which secure the shell sections to the internal lattice structure. Furthermore, in all the embodiments up to this point said internal means for securing had the form of an array of vertically spaced apart horizontal rings.

The present invention also envisions an embodiment wherein a monolithic type shell is secured to the internal lattice structure by means of an array of horizontally spaced apart, substantially vertical beams, having exterior surfaces matching the interior surface of the shell. This type embodiment, however, has the disadvantage of increased risk of undesirable transferability of stresses between the internal lattice structure and the shell.

The present invention lays out, however, also a totally different series of embodiments of the shell's construction, in which the means used for securing the shell to the lattice structure have an additional role of bonding between separable longitudinal segments of which the shell is made, hence said means of securing can be defined as forming integral part of the structure of the shell. Said means of securing comprise, in this case, an array of sufficiently stiff, horizontally spaced apart metal profiles, well fastened to said lattice structure, the axis of each of said metal profiles being contained within a vertical radial plane that is defined also by the tower's central vertical axis.

Said metal profiles divide the entire shell into an array of said separable longitudinal shell segments, such that each said metal profile is used to hold together two adjacent longitudinal shell segments, each located on either side of said profile.

It will be appreciated that this series of embodiments is most suitable to construct a shell that has the shape of a prism or a truncated pyramid, with equi-sided polygonal cross-section, as in said shape each of said separable longitudinal shell segments may be completely planar, hence the cost of fabricating said shell segments may be reduced considerably.

The same structural considerations as well as fabrication considerations, that are described above in explaining why a monolithic shell should preferably be broken apart, along its height, into a plurality of separable shell sections, apply basically to the presently described series of embodiments as well. Accordingly, in the preferred embodiment, the entire shell is divided along its entire height into a plurality of separable shell sections, such that in every joint between every two adjacent shell sections: (a) Said metal profiles are set apart into separate co-axial profile sections, with a relatively small gap there between, and (b) Said longitudinal shell segments are set apart into separable segment sections as well, but such that the upper segment section is extended, at its bottom, so as to overlap a relatively small portion at the top of the lower segment section in the joint.

The construction of the joint between every two adjacent shell sections, as described above, is meant to ensure, here as well, that minimal transferability of vertical stresses through said joint may exist.

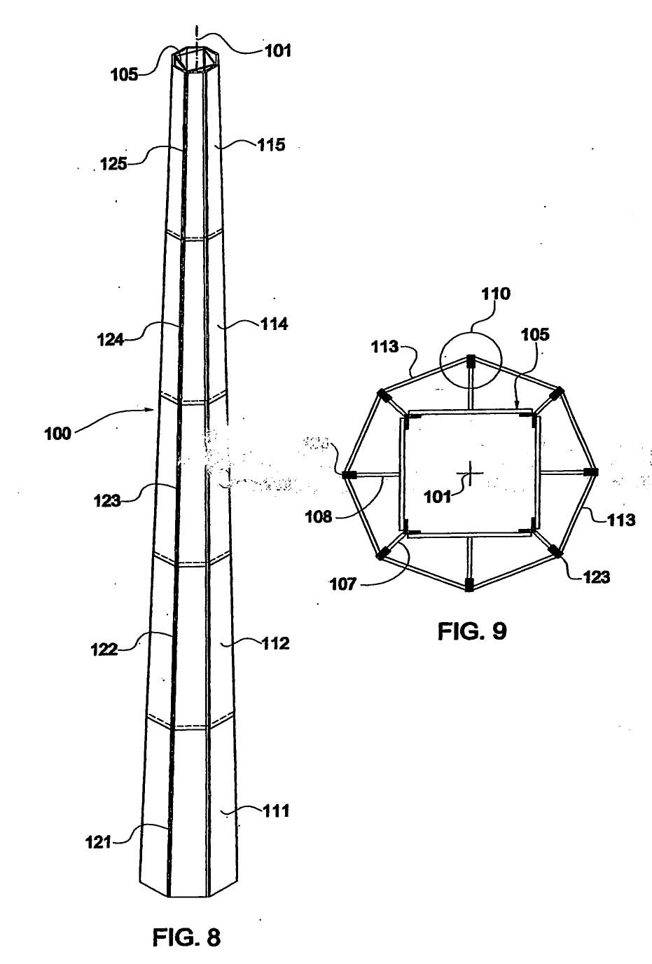

FIG. 8 illustrates a tower 100, constructed according to a preferred embodiment belonging to the presently described series of embodiments. The internal lattice structure 105 of tower 100 is of a square cross-section, and may be substantially similar to the internal lattice structure 15 illustrated in FIGS. 3 and 5. The non-structural outer shell has the shape of a truncated pyramid with an octagonal cross-section, such that both the internal lattice structure 105 and the outer shell have a common central vertical axis 101.

The entire height of the shell illustrated in FIG. 8 is divided, in this embodiment, into five shell sections, such that the bottom-most section comprises eight metal profiles 121 as well as eight planar longitudinal shell segments 111 there between, and respectively the second section comprises eight metal profiles 122 as well as eight shell segments 112, the third section comprises eight metal profiles 123 as well as eight shell segments 113, the fourth section comprises eight metal profiles 124 as well as eight shell segments 114 and the fifth (top) section comprises eight metal profiles 125 as well as eight shell segments 115 there between.

FIG. 8 also shows that a relatively small overlap exists between every two vertically adjacent shell segments, such as for example, vertically adjacent segments 113 and 112, so that the bottom of segment 113 covers (on the outside) a relatively small top portion of segment 112.

FIG. 8 also shows that the metal profiles are discontinued and broken apart in all said segment overlap locations, although a positional continuity (i.e. a common profile axis) is maintained along every corner line of the shell. In each of these discontinuation points a small gap is kept between adjacent vertical profile sections, but large enough to ensure that when the tower bends, the shell sections may freely slip, one relative to the other, in the joints.

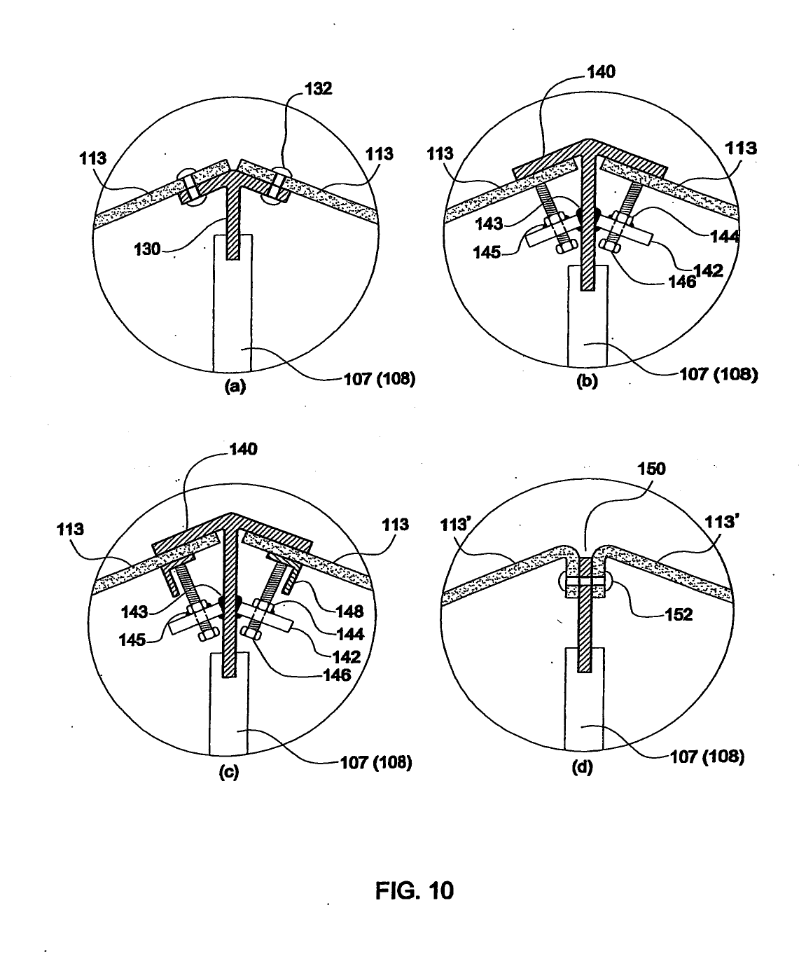

FIG. 9 is a horizontal cross-section taken through the third shell section of tower 100 of FIG. 8. The internal square section lattice structure 105 (made also in this embodiment of “L” shape metal members) is seen concentric with the octagonal section shell comprising eight metal profiles 123 as well as eight planar shell segments 113.

There are a large number of possible details for the construction of the metal profiles and the connections between them and the shell segments, a detail which is marked by detail circle 110. For this reason, FIG. 9 provides only a very schematic illustration of the contents of circle 110, in any of the eight shell sections, while FIG. 10 provides four alternative detailed embodiments for the contents of detail circle 110.

Furthermore, the means 107 (at the lattice structure legs) and 108, by which the metal profiles 123 are connected to the lattice structure 105, are also illustrated in FIG. 9 in the most schematic manner. The reason here again is that the exact details of said means of connection 107 and 108 may be any desired type out of numerous connection and fastening means known in the art, which may be applicable to this case.

Referring now to the four detail embodiments illustrated in FIG. 10, it can be seen that in the embodiments illustrated in FIGS. 10(a), 10(b) and 10(c), the metal profile 130 (140) are shown as “T” shapes, their outwardly facing flanges being bent inwards, so as to form an angle between each of said flanges and said profile's web which matches the angle between the plane defined by each of said planar shell segment 113 and the radial plane defined by the axis of said metal profile and the tower's central vertical axis. It will be further appreciated that instead of “T” shapes, “I” shapes may be used without effecting the illustrated embodiments' principles.

In the embodiment illustrated in FIG. 10(a), the planar shell segments 113 are mounted onto the exterior faces of the bent flanges of the metal profiles 130, and the fastening there between is made by means of rivets 132. It will be appreciated that, if desired, alternative means of fastening may be used instead of rivets 132, such as tap screws, standard bolts or even gluing.

In the embodiment illustrated in FIG. 10(b), the planar shell segments 113 are mounted onto the interior faces of the bent flanges of the metal profiles 140, and the fastening there between is made by means of clamping bolts 146, installed on plates 142 welded to the interior of the metal profile 140, such that a matching threaded hole is provided in plate 142, or alternatively as illustrated, a matching nut 144 is welded thereto. This assembly is designed so as to press shell segments 113 firmly against the inner surface of the bent flanges of the metal profile 140.

FIG. 10(c) illustrates a certain improvement of the embodiment illustrated in FIG. 10(b), such that an additional metal plate or smaller profile (“L” profile 148 in the illustrated embodiment) is further introduced, such that clamping bolts 146 press on said additional metal plate or profile 148. The advantage of this improvement is that it provides a much more uniform magnitude pressing effect of shell segments 113 against the metal profile 140. It also facilitates reducing the density, and resultant number, of clamping bolts 146, as a further advantage.

FIG. 10(d) illustrates a somewhat different approach embodiment, compared to those previously described: In this embodiment, the cross-section of each of the metal profiles is a flat plate 150, and each of the longitudinal edges of the planar shell segments 113′ is bent inwards forming a connection lip, such that in the installed state, the flat plate 150 is located in between said connection lips of two adjacent shell segments 113′. The two abutting lips and the plate 150 there between are fastened altogether, in the illustrated embodiment, by means of rivets 152.

It will be appreciated that instead of the illustrated flat plate 150, a “T” shape or an “L” shape, having its web or one of its flanges respectively taking the role of the flat plate, may be used without affecting the illustrated embodiment's principles. It would be further appreciated that, if desired, alternative means of fastening may be used instead of rivets 152, such as tap screws, standard bolts or even gluing.

Finally, it will be appreciated that the same materials described above as suitable for use to fabricate monolithic shell sections, or any of their non-planar segments, are also suitable for fabrication of the planar shell segments described herein. It will be further appreciated that, in the planar segment case, the utilization of materials which are readily available as large boards, such as metal plates of any kind, or even certain boards made of polymeric materials, have the potential of making a lower cost solution compared to a “tailored” composite material fabrication.

1. A tower, comprising a tall metal lattice structure having a central vertical axis and certain apparatus for its anchoring to a foundation, concealed within a shell concentric with said central vertical axis and further characterized, at any given level, by a closed cross-section which is either circular or equi-sided polygonal, said shell being internally secured to and supported by said metal lattice structure in an appropriate density throughout its area, so as to maintain its shape when subjected to wind loads or any other likely loads.

2. The tower according to claim 1, wherein said lattice structure includes at least three continuous leg members, each having either uniform or varying cross-section along its height, the axis of each leg being defined by either a straight or a broken line, contained within a vertical radial plane that is defined by and contains also said central vertical axis.

3. The tower according to claim 1, wherein said shell has the shape of either a cylinder or a truncated cone with a circular cross-section, or a prism or a truncated pyramid with an equi-sided polygonal cross-section.

4. The tower according to claim 1 wherein means for securing said shell to said lattice structure comprises an array of sufficiently stiff horizontal metal rings, having a respective circular or equi-sided polygonal shape, encircling and well fastened to said lattice structure, each in its designated level, the axes of all said rings being collinear with said central vertical axis and their exterior surfaces matching the internal surface of said shell in said designated levels respectively, said shell being mounted onto said array of rings and fastened thereto.

5. The tower according to claim 4, wherein the entire height of said shell is divided, for fabrication and assembly purposes, into a plurality of separable shell sections respectively, each having transportable dimensions, such that each shell section is directly fastened to at least one of said metal rings.

6. The tower according to claim 5, wherein the joint between every two adjacent said shell sections, once finally assembled, is made such that the bottom end of the upper of said sections is extending over the top end of the lower of said sections, so that a relatively small overlap exists there between, allowing vertical slip of the interior surface of the upper section relative to the exterior surface of the lower section.

7. The tower according to claim 6, wherein said joint is made such that a small gap exists between the exterior of the top end portion of the lower of said every two adjacent shell sections and the interior of the bottom portion of the upper of said two sections, and said gap is filled with a band of an elastic material, such as rubber, said band fulfilling a primary role of transmitting lateral forces between the bottom end of said upper section and the top end of said lower section while minimizing the transmission of vertical forces there between, and a secondary role of sealing the joint against wind-air or rain-water penetration.

8. The tower according to claim 6, wherein the top portion of the lower of said every two adjacent shell sections, where said joint is located, is dropped inwards all around, so as to make room for said overlap while keeping a substantially smooth and continuous exterior face of said shell sections on both sides of said joint.

9. The tower according to claim 7, wherein the top portion of the lower of said every two adjacent shell sections, where said joint is located, is dropped inwards all around, so as to make room for said overlap and said gap, while keeping a substantially smooth and continuous exterior face of said shell sections on both sides of said joint.

10. The tower according to claim 6, wherein each of said shell sections is fastened to only one of said metal rings, located behind the top end portion of the respective shell section.

11. The tower according to claim 5, wherein each, or any desired part of, said shell sections is further divided, for fabrication and assembly purposes, into a plurality of horizontally detachable segments, such that every two adjacent segments are coupled along a substantially vertical seam there between.

12. The tower according to claim 11, wherein said seam between every two adjacent segments is made by two internally bent and vertically abutting lips, each forming an integral part of a respective one of said two adjacent segments, such that a substantially vertical radial plane of contact exists there between, which is defined by and contains also said central vertical axis, said two abutting lips being mechanically coupled by means of conventional bolting, riveting, gluing or the like.

13. The tower according to claim 5, wherein said shell is made of fiberglass material or any other composite material.

14. The tower according to claim 5, wherein said shell is made of relatively thin metal sheeting.

15. The tower according to claim 1, wherein means for securing said shell to said lattice structure comprises an array of sufficiently stiff, horizontally spaced apart metal beams, well fastened to said lattice structure, the axis of each of said metal beams being contained within a vertical radial plane that is defined by and contains also said central vertical axis; the exterior surfaces of said metal beams matching the internal surface of said shell in said designated beam locations respectively, said shell being mounted onto said array of metal beams and fastened thereto.

16. The tower according to claim 1, wherein means for securing said shell to said lattice structure forms a part of the structure of said shell, and comprises an array of sufficiently stiff, horizontally spaced apart metal profiles, well fastened to said lattice structure, the axis of each of said metal profiles being contained within a vertical radial plane that is defined by and contains also said central vertical axis; said shell being divided by said array of metal profiles into an array of separable longitudinal shell segments each of said longitudinal segments being fastened, along both its longitudinal, substantially vertical edges, to two of said metal profiles, adjacently located.

17. The tower according to claim 16, wherein each of said separable longitudinal shell segments is substantially planar, consequently the entire said shell has a shape of a prism or a truncated pyramid, with an equi-sided polygonal cross-section.

18. The tower according to claim 16, wherein said entire shell is divided along its entire height into a plurality of separable shell sections, such that in every joint between every two adjacent shell sections:
said metal profiles are set apart into separate co-axial profile sections, with a
relatively small gap there between, and
said longitudinal shell segments are set apart into separable segment sections as well, but such that the upper segment section is extended, at its bottom, so as to overlap a relatively small portion at the top of the lower segment section in the joint.

19. The tower according to claim 17, wherein the cross-section of each of said metal profiles is a “T” or an “I” shape, with outwardly facing flanges which are bent inwards, so that the angle between each of said flanges and said profile's web matches the angle between the plane defined by said planar shell segment and the radial plane defined by the axis of said metal profile and said central vertical axis.

20. The tower according to claim 19, wherein said planar shell segments are mounted onto the exterior faces of said metal profiles' outwardly facing flanges, and the fastening there between is made by means of tap-screwing, riveting or bolting.

21. The tower according to claim 19, wherein said planar shell segments are mounted onto the interior faces of said metal profiles' outwardly facing flanges, and the fastening there between is made by means of clamping bolts, installed on plates welded to said metal profiles' interior, so as to press said shell segments firmly against the inner surface of said metal profiles' outwardly facing flanges.

22. The tower according to claim 21, wherein in each of the longitudinal connection between said shell segments and said metal profiles, an additional metal plate or smaller profile is present, such that said clamping bolts press on said additional metal plate or smaller profile, so as to provide an improved effect of clamping the longitudinal edges of said shell segments continuously.

23. The tower according to claim 17, wherein the cross-section of each of said metal profiles is a flat plate, or a “T” shape with inwardly facing flanges, and each of said planar shell segments' longitudinal edges is bent inwards forming a connection lip, such that in the installed state, each of said flat plates, or the webs of said “T” shapes, are located in between said connection lips of every two adjacent shell segments; the two abutting lips and the profile there between being fastened altogether by means of tap-screwing, riveting or bolting.

24. The tower according to claim 16, wherein said shell segments are made of fiberglass material or any other composite material, or any polymeric material.

25. The tower according to claim 16, wherein said shell segments are made of relatively thin metal sheeting.
